(19) United States
(12) Patent Application Publication
(10) Pub. No.: US 2025/0157318 A1
(43) Pub. Date: May 15, 2025

(54) ALARM SYSTEM AND ALARM METHOD FOR ELECTRONIC DEVICES, AND NON-TRANSITORY STORAGE MEDIUM

(71) Applicant: DELTA ELECTRONICS, INC., Taoyuan City (TW)

(72) Inventors: Yi-Kuan KE, Taoyuan City (TW); Chih-Han KO, Taoyuan City (TW); Yi-Kai TSENG, Taoyuan City (TW)

(21) Appl. No.: 18/945,302

(22) Filed: Nov. 12, 2024

Related U.S. Application Data
(60) Provisional application No. 63/599,317, filed on Nov. 15, 2023.

(30) Foreign Application Priority Data
Sep. 4, 2024 (CN) 202411235050.8

(51) Int. Cl. G08B 29/02; G06F 3/04817

(52) U.S. Cl. CPC G08B 29/02; G06F 3/04817

(57) ABSTRACT

An alarming system for electronic devices is disclosed and includes: a graphical control page, used for displaying device icons of multiple electronic devices; a device alarm identification module, used for creating an alarm array based on alarm points and alarm codes of each electronic device, where each alarm code respectively corresponds to different alarm level; a register, used for storing respective device real-time data and the alarm array of the multiple electronic devices; a click detection module, used for detecting one of the device icons being clicked to correspondingly read device real-time data and display on the graphical control page; a real-time data refresh module, used for refreshing the graphical control page based on the data in the register in a preset cycle; and an icon rendering module, used for rendering a display color of each device icon based on the data in the register.

### CROSS-REFERENCE TO RELATED APPLICATION

This patent application claims the benefit of U.S. Provisional Patent Application No. 63/599,317, filed Nov. 15, 2023, which is incorporated by reference herein.

### BACKGROUND OF THE DISCLOSURE

### Technical Field

The disclosure relates to an alarm system, particularly relates to an alarm system for real-time monitoring of electronic devices in a site.

### Description of Related Art

In current substations, utilizing monitoring systems for real-time management of a power system is an indispensable part.

Recently, energy structures have become more complex, and the power system has become more intelligent. Moreover, various new energy devices are continuously added to a power network. In contrast, the existing monitoring system is still based on design of old generation of the power system (e.g., SCADA), making it challenging for users to interact effectively with the monitoring system, and to monitor real-time data alarms.

In view of this, how to improve the monitoring system based on new generation of the power system, thereby enabling the user to utilize the monitoring system to manage a site in a more concise and effective manner, is a major issue in the field of smart power grid development.

### SUMMARY OF THE INVENTION

The purpose of the disclosure is to provide an alarm system for electronic devices, an alarm method, and a non-transitory storage medium, which enable a user to directly monitor data from various devices, obtain real-time alarms from a single page, and simplify complexity of operations and use of traditional monitoring systems.

In one embodiment, the disclosure provides the alarm system for electronic devices connected with multiple electronic devices in an environment and including:
a graphical control page, configured for displaying a device icon of the multiple electronic devices respectively;
a device alarm identification module, configured for respectively decoding an alarm point of each of the electronic devices, and creating an alarm array based on the alarm points and multiple alarm codes of the multiple electronic devices, where each of the alarm codes respectively corresponds to different alarm level;
a register, configured for storing respective device real-time data and the alarm array of the multiple electronic devices;
a click detection module, configured for when detecting that the device icon of any of the electronic devices is clicked, reading the device real-time data of the electronic device being clicked from the register, and displaying the device real-time data of the electronic device being clicked on the graphical control page;
a real-time data refresh module, configured for repeatedly reading the register and refreshing displayed content of the graphical control page based on a preset cycle; and an icon rendering module, configured for rendering a display color of the device icon of the multiple electronic devices based on the data stored in the register, where the display color corresponds to a highest alarm level currently experienced by the respective device.

In one embodiment, the disclosure provides the alarm method for electronic devices, applied to an alarm system connected with multiple electronic devices in an environment, and including:
by a graphical control page in the alarm system, displaying a device icon of the plurality of electronic devices respectively;
by a device alarm identification module in the alarm system, respectively decoding an alarm point of each of the electronic devices, and creating an alarm array based on the alarm point and multiple alarm codes of the multiple electronic devices, where each of the alarm codes respectively corresponds to different alarm level;
storing respective device real-time data and the alarm array of the plurality of electronic devices to a register in the alarm system;
when detecting that the device icon of any of the electronic devices is clicked, by a click detection module in the alarm system, reading the device real-time data of the electronic device being clicked from the register, and displaying the device real-time data of the electronic device being clicked on the graphical control page;
by a real-time data refresh module in the alarm system, repeatedly reading the register and refreshing displayed content of the graphical control page based on a preset cycle; and
by an icon rendering module in the alarm system, rendering a display color of the device icon of the multiple electronic devices based on data in the register, where the display color corresponds to a highest alarm level currently experienced by the respective device.

In one embodiment, the disclosure provides the non-transitory storage medium to store an application program having multiple computer-readable codes, and to execute the steps of the above alarm method for electronic devices when executing the multiple computer-readable codes.

The disclosure provides the graphical control page to display a dynamic single-line diagram corresponding to a power network in a site, and when any electronic device on the dynamic single-line diagram is clicked, the disclosure provides the real-time data and all alarm items of the electronic device being clicked on the single page. Compared to related technologies, the alarm system and alarm method in the disclosure significantly simplify the complexity of operations and use of the monitoring system.

### BRIEF DESCRIPTION OF THE DRAWINGS

FIG. 1 is a schematic diagram of connection of a system of the disclosure.

FIG. 2 is a block diagram of an alarm system of the disclosure.

FIG. 3A is a first embodiment of a schematic diagram of a graphical control page of the disclosure.

FIG. 3B is a second embodiment of a schematic diagram of the graphical control page of the disclosure.

FIG. 4 is an embodiment of an alarm flowchart of the disclosure.

FIG. 5 is an embodiment of a schematic diagram of information reception of the disclosure.

FIG. 6 is an embodiment of a flowchart of the information reception of the disclosure.

FIG. 7A is a part of a refresh flowchart of the disclosure.

FIG. 7B is another part of the refresh flowchart of the disclosure.

FIG. 8A is a third embodiment of a schematic diagram of the graphical control page of the disclosure.

FIG. 8B is an embodiment of a flowchart of the device control of the disclosure.

FIG. 9 is an embodiment of a flowchart of expanding an alarm field of the disclosure.

FIG. 10 is an embodiment of a flowchart of rendering of the disclosure.

### DETAILED DESCRIPTION

The disclosure discloses an alarm system for electronic devices, which connects multiple electronic devices being surrounded by wired or wireless manners. After receiving real-time data from these electronic devices, the alarm system not only displays real-time values of each electronic device on a single page based on user requirement, but also provides real-time alarms after decoding the data from these electronic devices. In this way, the user directly obtains sufficiently rich information on the single page, thereby overcoming problem of poor operability of traditional monitoring systems.

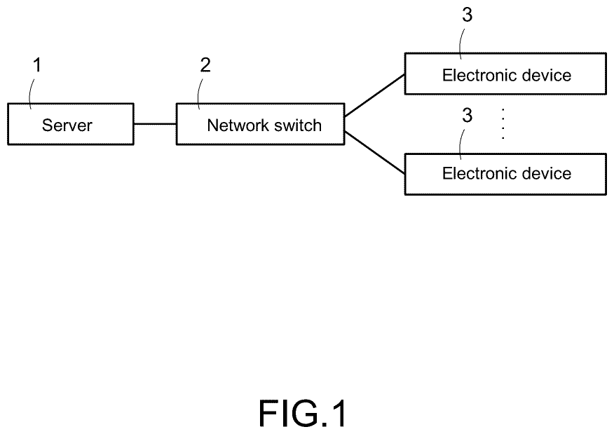

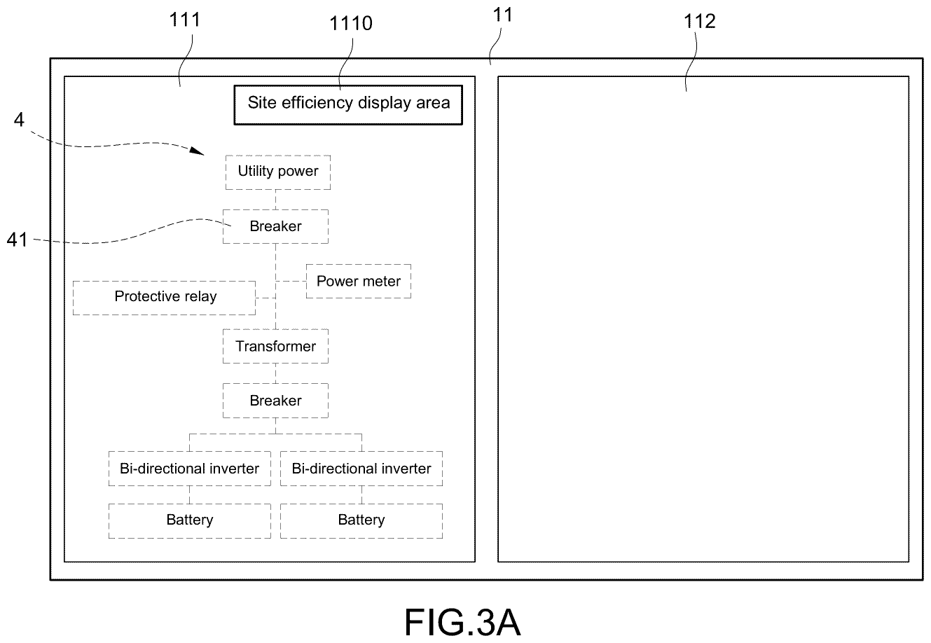

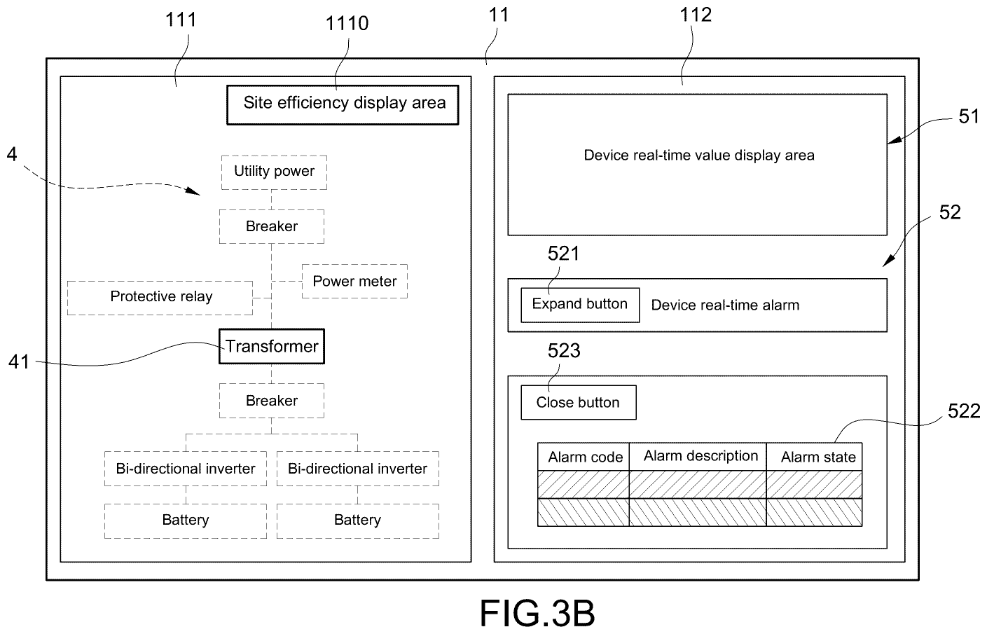

Reference is made to FIG. 1, and FIG. 1 is a schematic diagram of connection of a system of the disclosure. The alarm system of the disclosure is implemented in a server 1 by a manner of a combination of software and hardware. As shown in FIG. 1, the server 1 is communicatively connected to a network switch 2, and the network switch 2 is connected to multiple electronic devices 3 in a site where network switch 2 is located. In this way, the server 1 connects to the multiple electronic devices 3 in the site through the network switch 2 to receive and store device real-time data of these electronic devices 3 and displays these data on a graphical control page (e.g., the graphical control page 11 shown in FIG. 3A and FIG. 3B) in the alarm system.

In one embodiment, the multiple electronic devices 3 include various electronic devices in a smart power grid, such as a digital power meter, a breaker, a protective relay, a bi-directional inverter, a battery, a transformer, etc., but is not limited thereto. The network switch 2 communicates with different electronic devices 3 through different communication protocols, such as Modbus, IEC61850, Ethernet, controller area network (CAN bus), etc., but not limited thereto. In the disclosure, the alarm system provides at least one graphical control page 11 through the server 1. One of the technical features of the disclosure is that the alarm system receives the real-time data of the multiple connected electronic devices 3, directly displays the real-time data of one or more electronic devices 3 through the single page on the graphical control page 11 after decoding, and performs the real-time alarms for these real-time data. In this way, the user quickly notices abnormality of the one or more electronic devices and starts to maintain or replace the one or more electronic devices.

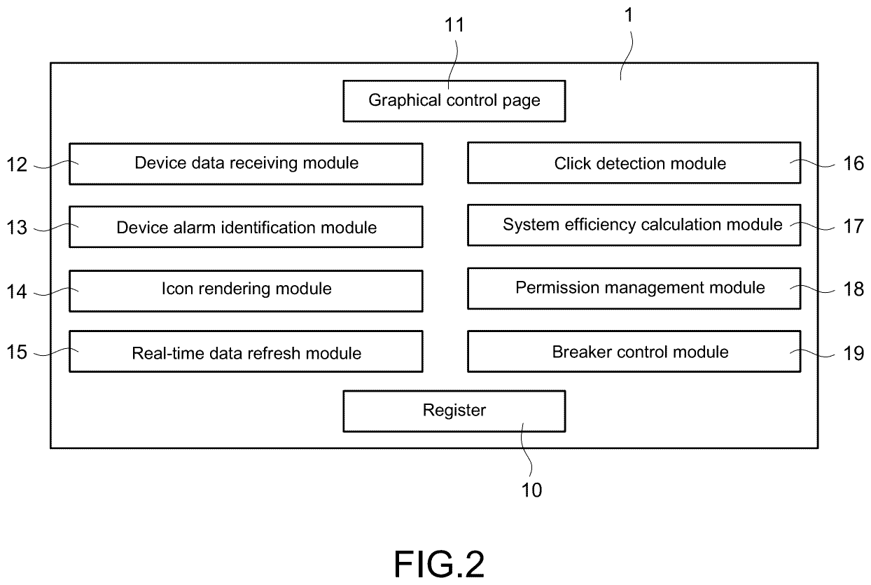

Reference is made to FIG. 2, and FIG. 2 is a block diagram of the alarm system of the disclosure. As shown in FIG. 2, the alarm system of the disclosure is implemented by the server 1 and includes, but is not limited to, the graphical control page 11, a device data receiving module 12, a device alarm identification module 13, an icon rendering module 14, a real-time data refresh module 15, a click detection module 16, a system efficiency calculation module 17, a permission management module 18, and a breaker control module 19. Specifically, the server 1 of the disclosure is a device with a processor and a non-transitory storage medium (e.g., a memory, a hard drive, or an optical disk), such as a personal computer, an industrial computer, a local server, an industrial server, or a cloud server. The server 1 stores an application program through the non-transitory storage medium, and the application program has multiple computer-readable codes. After the server 1 executes the multiple computer-readable code by the processor, the graphical control page 11 and the multiple modules 12-19 are created virtually in the server 1, so that the server 1 constitutes the alarm system of the disclosure and implements an alarm method of the disclosure by the graphical control page 11, the multiple modules 12-19, and the register 10 (implemented in software or hardware).

In one embodiment, the register 10 is implemented by a hard disk, a solid-state drive, a memory, or the above non-transitory storage medium.

The graphical control page 11 is used for simulating and displaying a power network formed by all electronic devices 3 in the site where the alarm system is located. The device data receiving module 12 is used for receiving the device real-time data from all electronic devices 3 connected to the server 1. The device alarm identification module 13 is used for decoding whether each electronic device 3 has alarm events. The icon rendering module 14 is used for updating a color of a device icon of each electronic device 3 displayed on the graphical control page 11 based on an alarm state of each electronic device 3. The real-time data refresh module 15 is used for periodically refreshing displayed content of the graphical control page 11. The click detection module 16 is used for detecting whether graphical control elements of each electronic device 3 displayed on the graphical control page 11 has been clicked. The system efficiency calculation module 17 is used for calculating energy efficiency of the system or each electronic device 3. The permission management module 18 is used for managing and identifying a control permission of the user over each electronic device 3. The breaker control module 19 is used for controlling breaker devices in the multiple electronic devices 3. The register 10 is used for storing the device real-time data and related alarm information of each electronic device 3.

Reference is made to FIG. 3A and FIG. 3B, and FIG. 3A and FIG. 3B respectively are a first embodiment and a second embodiment of the schematic diagram of the graphical control page of the disclosure. As shown in FIG. 3A, the graphical control page 11 displays two types of information, including the device icons 41 of the multiple electronic devices 3 connected to the alarm system (i.e., the server 1) and device real-time data of the multiple electronic devices 3. In one embodiment, the graphical control page 11 includes a first display area 111 (also known as a dynamic single-line diagram display panel) and a second display area 112 (also known as a real-time data display panel), where the device icons 41 are displayed on the first display area 111, and the device real-time data is displayed on the second display area 112.

As shown in FIG. 3A, the device icons 41 of the multiple electronic devices 3 displayed on the graphical control page 11 constitute a dynamic single-line diagram 4, and this dynamic single-line diagram 4 corresponds to the power network formed by the multiple electronic devices 3 in a real environment. Specifically, the user first observes the power network in the actual site, and then constitutes a corresponding dynamic single-line diagram 4 in the alarm system based on the power system architecture actually including the power network (i.e., the dynamic single-line diagram 4 is customized based on the actual site). In this way, when the alarm system indicates that an alarm event for any electronic device 3 needs to be troubleshooted by the graphical control page 11, the user quickly finds an actual position of this electronic device 3 by utilizing the dynamic single-line diagram 4 in the power system and troubleshoot and repair the error.

In one embodiment, the graphical control page 11 initially displays the device real-time data of each electronic device 3, displays comprehensive data of all electronic devices 3, or displays data of one or more electronic devices 3 that are more important among the multiple electronic devices 3, but is not limited thereto. For example, the graphical control page 11 displays a dynamic single-line diagram 4 of the multiple electronic devices 3 on the first display area 111, and displays power information of a power meter in the site, data of a protective relay in the site, and device information of other important devices (e.g., important devices automatically identified by the alarm system or by a user device) in the site on the second display area 112.

In addition, the graphical control page 11 further provides a site efficiency display area 1110 on the first display area 111. The site efficiency display area 1110 is used for displaying system efficiency of the multiple electronic devices 3 in the site where the multiple electronic devices 3 are located. For example, the alarm system obtains throughput (i.e., total incoming power and total outgoing power) of all power meters of the multiple electronic devices 3 connected to the alarm system and calculates the system efficiency. For a further example, the alarm system obtains the throughput of an uppermost power meter in the multiple electronic device 3 and calculates the system efficiency. In the disclosure, the alarm system displays the system efficiency on the site efficiency display area 1110 of the graphical control page 11 to present power conversion efficiency of all electronic devices 3 in the site.

One of the technical features of the disclosure is that all device icons 41 of the electronic devices 3 displayed on the graphical control page 11 are individually clickable. When one device icon 41 is clicked, the displayed content of the second display area 112 changes accordingly. As shown in FIG. 3B, when a device icon 41 of any electronic device 3 is clicked, the second display area 112 switches to display the device real-time data and the related alarm information about the electronic device 3 being clicked. In the embodiment of FIG. 3B, the second display area 112 has a device real-time value display area 51 and an alarm area. The device real-time value display area 51 displays the device real-time data of the electronic device 3 being clicked (FIG. 3B utilizes the transformer 41 as an example), and the alarm area displays one or more alarm fields 52, where the one or more alarm fields 52 display one or more alarm events of the electronic device 3 being clicked.

In the disclosure, the multiple alarm fields 52 correspond to different alarm types, for example, if 10 alarm types exist, the second display area 112 provides 10 alarm fields 52. In other words, the alarm system categorizes the multiple alarm events of the electronic device 3 based on the multiple alarm types and separately displays the different alarm types of alarm events with different alarm fields 52. As shown in FIG. 3B, the multiple alarm fields 52 are defaulted to a collapsed state and each alarm field 52 has an expand button 521. When the expand button 521 on one of the alarm fields 52 is triggered, the alarm field 52 switches to an expanded state, and the expanded alarm field 52 presents the alarm events (including alarm codes, alarm descriptions, and alarm states) of the electronic device 3 matched to this alarm type in an alarm table 522. It should be noted that the alarm table 522 includes multiple alarm rows, each row records one alarm event (at least including the alarm code of this alarm event) of the electronic device 3. In the disclosure, each alarm row is rendered to a different color, which corresponds to the color assigned to alarm level corresponding to the alarm code recorded in the alarm row (details in the following).

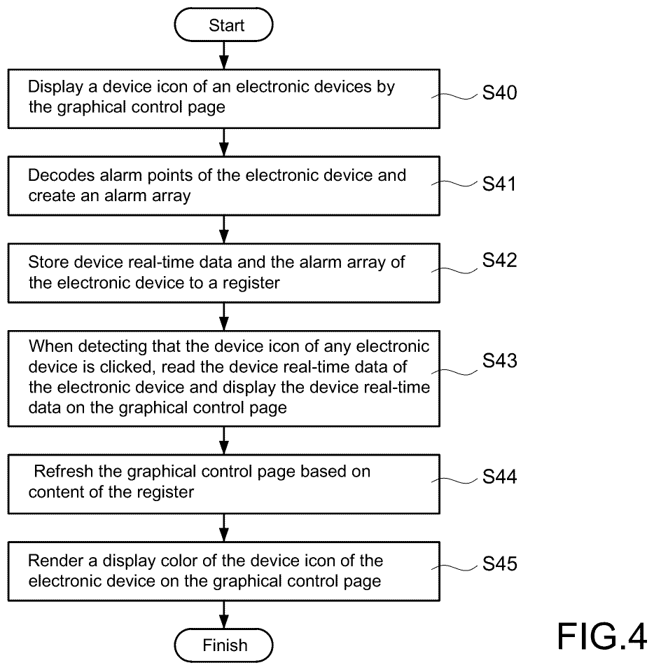

Continuously, reference is made to FIG. 4, and FIG. 4 is an embodiment of an alarm flowchart of the disclosure. FIG. 4 discloses specific steps of the alarm method of the disclosure, and this alarm method is applied to the alarm system shown in FIG. 2 and the graphical control page 11 shown in FIGS. 3A and 3B.

As shown in FIG. 4, after the alarm system is activated (e.g., the server 1 is activated), the device real-time data of the multiple electronic devices 3 connected the alarm system is received, and the device icons 41 of the multiple electronic devices 3 are displayed by the graphical control page 11 (step S40). In one embodiment, the graphical control page 11 displays the dynamic single-line diagram 4 constituted by the multiple device icons 41 to present the actual power network on the first display area 111.

When receiving the device real-time data of the multiple electronic devices 3, the alarm system respectively decodes alarm points of each electronic device 3 by the device alarm identification module 13 and creates an alarm array based on the alarm points and the multiple alarm codes of the multiple electronic devices 3 (step S41). In other words, the alarm array can at least record the alarm codes for one or more alarm events currently experienced by each electronic device 3. In one embodiment, the multiple alarm codes correspond to different alarm levels, such as first level (highest level), second level (second highest level), third level (lowest level), no alarm, etc. In one embodiment, the multiple alarm codes also correspond to different alarm descriptions and different alarm states.

Specifically, when confirming the multiple electronic devices 3 used in the actual site and creating the dynamic single-line diagram 4 on the alarm system, the user simultaneously writes basic information of the multiple electronic devices 3 into the alarm system, which includes, for example, the alarm points and the alarm codes native to each electronic device 3. When the alarm system receives the device real-time data of any electronic device 3, the device alarm identification module 13 decodes the device real-time data based on the known alarm points of the electronic device 3 so that determines whether the electronic device 3 has alarm events, what the alarm code of the alarm event is, and what the alarm level corresponds to the alarm code. After the device alarm identification module 13 finishes decoding, the alarm system instantly displays the above information on the graphical control page 11 for quick reference by the user.

After step S41, the alarm system stores the respective device real-time data and the alarm array of the multiple electronic devices 3 to the register 10 (step S42). In the disclosure, the alarm system continuously executes steps S40-S42 during operation to continuously receive the device real-time data of the multiple electronic devices 3, decode the alarm events of the multiple electronic devices 3, and update content of the register 10. Moreover, the graphical control page 11 periodically reads the data in the register 10 and refreshes displayed content of the graphical control page 11 based on a preset cycle, so that the displayed content of the graphical control page 11 is synchronized with the content of the register 10.

On the other hand, the alarm system continuously detects whether the device icon 41 displayed on the graphical control page 11 is clicked during operation by the click detection module 16. When the click detection module 16 detects that the device icon 41 of any electronic device 3 is clicked, the alarm system reads the device real-time data of the electronic device 3 being clicked from the register 10 and displays the device real-time data on the graphical control page 11 (step S43). In one embodiment, when any of the device icons 41 displayed on the first display area 111 of the graphical control page 11 is clicked, the alarm system switches the displayed content of the second display area 112 to display related information of the electronic device 3 being clicked.

Furthermore, the alarm system continues to periodically read the register 10 (i.e., obtaining the latest data of the register 10) by the real-time data refresh module 15 during operation, and refreshes the displayed content of the graphical control page 11 based on the content of the register 10 (step S44). By continuously executing steps S40-S42, and S44, the alarm system updates latest information of the multiple electronic devices 3 on the graphical control page 11 in real-time.

As previously described, the device real-time data and the alarm array of the multiple electronic devices 3 are recorded in the register 10 so the alarm system identifies the alarm state of each electronic device 3 based on the content of the register 10. In the disclosure, the alarm system also parses the data obtained from the register 10 by the icon rendering module 14, and respectively renders a display color of each device icon 41 of the multiple electronic devices 3 on the graphical control page 11 (step S45), where the display color of each device icon 41 corresponds to the alarm level currently being highest experienced by each electronic device 3. For example, if the power meter has no alarm event, the icon rendering module 14 renders the device icon 41 corresponding to the power meter to green; if the transformer has multiple alarm events and the highest alarm level is the first level (highest level), the icon rendering module 14 renders the device icon 41 corresponding to the transformer to red; and if the battery has multiple alarm events and the highest alarm level is the second level (second highest level), the icon rendering module 14 renders the device icon 41 corresponding to the battery to yellow, and so on.

By using the alarm system of the disclosure, the user realizes the application of multiple functions to the multiple electronic devices 3 in the environment, including real-time monitoring, authority management, and hierarchical display of alarms, by the single graphical control page 11. Moreover, by combining the color rendering technology, the alarm system of the disclosure achieves a high degree of visualization, which is helpful for the user to improve the management efficiency of the site.

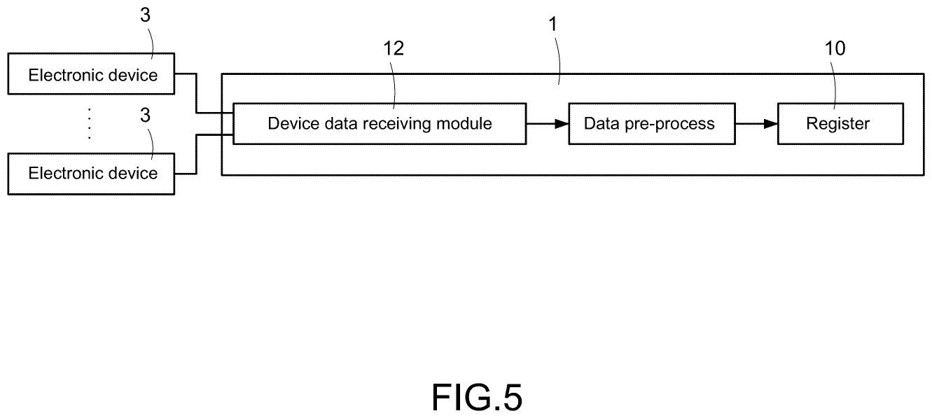

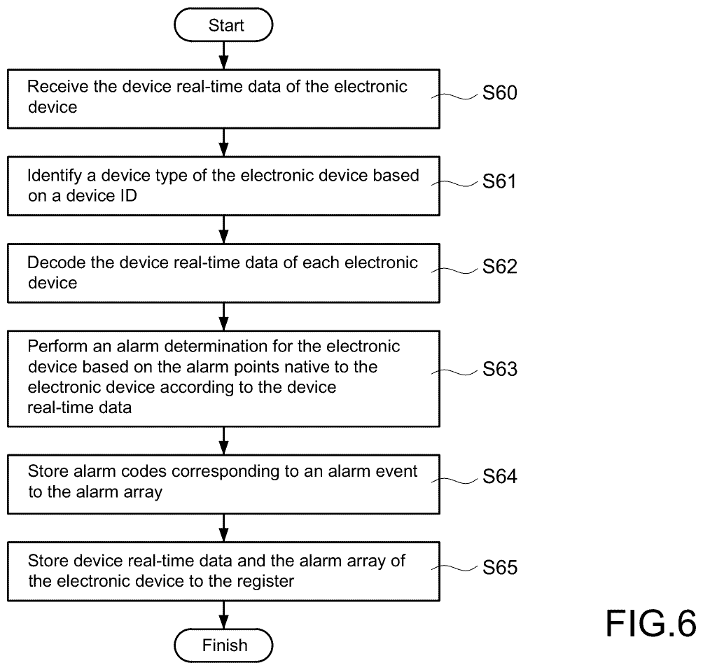

Reference is made to FIG. 5 and FIG. 6, where FIG. 5 is an embodiment of a schematic diagram of data reception of the disclosure, and FIG. 6 is an embodiment of a flowchart of data reception of the disclosure.

As shown in FIG. 5, the alarm system continuously receives the device real-time data from the multiple electronic devices 3 connected to the alarm system by the device data receiving module 12 and performs a data pre-processing procedure on the device real-time data before storing the device real-time data to the register 10. In one embodiment, the data pre-processing procedure includes, without limitation, identifying a device type of the electronic device 3, decoding the device real-time data, determining whether the electronic device 3 has the alarm event, obtaining the alarm code corresponding to the alarm event, and creating the alarm array.

As shown in FIG. 6, when the alarm system operates and connects to the multiple electronic devices 3, the device data receiving module 12 continuously receives the device real-time data of the multiple electronic devices 3 (step S60). Furthermore, the device data receiving module 12 obtains a device ID of each electronic device 3 and identifies the device type (e.g., the power meter, the transformer, or the bi-directional inverter, etc.) of each electronic device 3 based on the device ID (Step S61). Since different device types use different data formats, the device data receiving module 12 adopts a corresponding decoding manner based on the device type to respectively decode the device real-time data of each electronic device 3 (Step S62).

As previously described, each electronic device 3 respectively has the alarm points and the alarm codes, e.g., the alarm points and the alarms code are recorded in a specification table native to the electronic device 3. In the disclosure, the alarm system further calls the device alarm identification module 13, and the device alarm identification module 13 performs an alarm determination for each electronic device 3 based on the alarm points native to the multiple electronic devices 3 according to the device real-time data (step S63). In other words, the device alarm identification module 13 determines whether each electronic device 3 currently has the alarm event based on the device real-time data. When determining that any electronic device 3 has the alarm event, the device alarm identification module 13 stores the alarm codes corresponding to the alarm event to the alarm array (step S64). In another embodiment, the device alarm identification module 13 writes the alarm codes, the alarm descriptions, and the alarm states corresponding to all alarm events of each electronic device 3 into the alarm array one by one.

For example, the electronic device 3 has 100 native alarm points, which means that this electronic device 3 has 100 alarm codes. In this embodiment, if the device alarm identification module 13 determines that the electronic device 3 has three alarm events corresponding to the alarm code 3, the alarm code 10, and the alarm code 18, the device alarm identification module 13 stores each of these three alarm codes to the alarm array. This means that a length of the alarm array is three.

After all alarm related information of all electronic devices 3 is written into the alarm array (which can be one or more alarm arrays), the device alarm identification module 13 respectively stores the device real-time data and the alarm array of each electronic device 3 to the register 10 based on the device ID of each electronic device 3 (Step S65).

The data stored in the register 10 by the device alarm identification module 13 at step S65 are regarded as raw data of the alarm system. After step S65, the alarm system refreshes the displayed content of the graphical control page 11 based on the raw data in the register 10, so that the user quickly, intuitively, and visually obtains detailed information about the multiple electronic devices 3. Moreover, during the operation of the alarm system, the alarm system continuously receives the devices real-time data of the multiple electronic devices 3 and continuously updates the raw data in the register 10 based on the process described above.

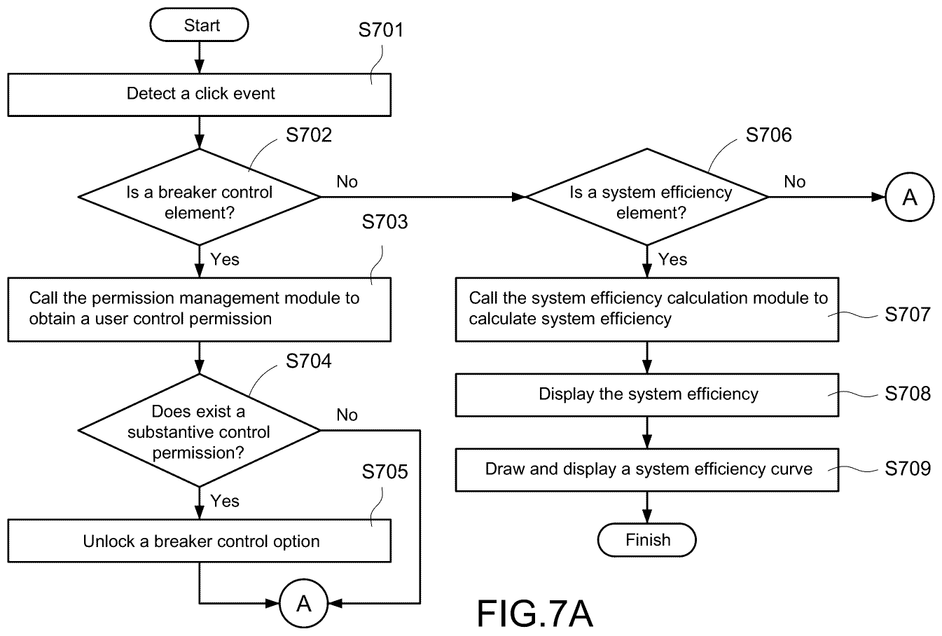

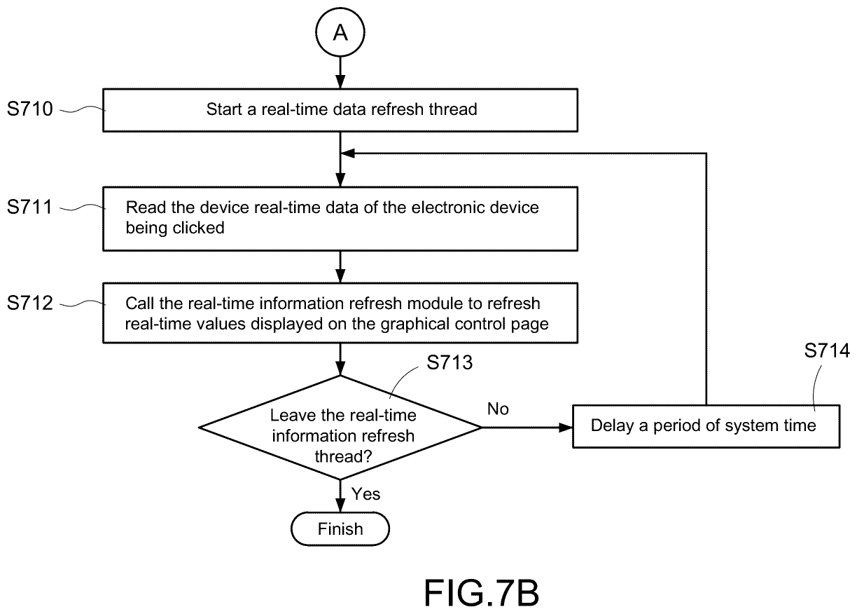

Reference is made to FIG. 7A and FIG. 7B, and FIG. 7A and FIG. 7B are a refresh flowchart of the disclosure. FIG. 7A and FIG. 7B disclose specific steps executed by the alarm system after any device icons 41 on the graphical control page 11 is clicked.

Specifically, the alarm system continuously detects whether any device icon 41 displayed on the graphical control page 11 has been clicked by the click detection module 16 during operation (step S701). when detecting a click behavior, the click detection module 16 determines whether the electronic device being clicked is a breaker control element (step S702), a system efficiency element (step 706), or a general element (step A, i.e., neither the breaker control element nor the system efficiency element). For example, the click detection module 16 obtains the device ID of the electronic device 3 and identifies the device type of the electronic device 3 based on the device ID. In the disclosure, when any device icon 41 is clicked, the second display area 112 of the graphical control page 11 is switched to display the detailed information about the electronic device 3 being clicked, and the displayed content of the second display area 112 varies depending on the device type (i.e., the breaker control element, the system efficiency element, and the general element) of the electronic device 3 being clicked.

As shown in FIG. 7B, if the click detection module 16 identifies that the electronic device 3 being clicked is a general component, the alarm system starts a real-time data refresh thread (step S710). In the disclosure, the alarm system continuously refreshes the information related to the electronic device 3 being clicked and displayed on the graphical control page 11 by the real-time data refresh thread.

Specifically, the alarm system queries the register 10 based on the device ID of the electronic device 3 being clicked to read the device real-time data of the electronic device 3 being clicked in the register 10 (step S711). Next, the alarm system calls the real-time data refresh module 15, and the real-time data refresh module 15 refreshes the various real-time values displayed on the second display area 112 of the graphical control page 11 based on the obtained real-time data of the device (step S712). It should be noted that the real-time values include the device real-time data displayed on the device real-time value display area 51 and one or more alarm fields 52 displayed on the alarm area.

The alarm system continuously determines whether to leave the real-time data refresh thread (step S713). Before leaving the real-time data refresh thread, the alarm system delays for a period of system time (e.g., 0.5 ms or 1 s) (step S714), and then repeats steps S711 and S712. In this way, the displayed content of the second display area 112 is synchronized with the content of the register 10, so that enables the user to directly view the real-time value of the electronic device 3 being clicked on the graphical control page 11. In one embodiment, the alarm system, for example, leaves the current real-time data refresh thread when the user triggers an exit button (not shown) on the graphical control page 11 or clicks another device icon 41 of another electronic device 3 in the first display area 111.

Back to FIG. 7A, if identifying that the electronic device 3 being clicked is the site efficiency element after step S701 (i.e., determining to be yes in step S706), the alarm system reads the device real-time data of the electronic device 3 being clicked from the register 10, and calls the system efficiency calculation module 17 to calculate the system efficiency of the electronic device 3 being clicked based on the device real-time data (step S707). Next, the alarm system displays the calculated system efficiency on the second display area 112 of the graphical control page 11 (step S708). In one embodiment, the system efficiency calculation module 17 also draws a corresponding system efficiency curve graph based on the system efficiency, and the alarm system displays the system efficiency curve graph on the second display area 112 at the same time (step S709). In an embodiment, the system efficiency curve graph is, for example, a bar graph or a line graph, but not limited thereto.

If identifying that the electronic device 3 being clicked is the breaker control element after step S701 (i.e., determining to be yes in step S702), the alarm system calls the permission management module 18 to obtain a user control permission for a current user (step S703). The current user is, for example, a holder of a current login account for the alarm system. Next, based on the obtained user control permission, the alarm system determines whether the current user has a substantive control permission over the breaker control element being clicked (Step S704), i.e., determines whether the current user is allowed to operate the breaker control element being clicked. If determining that the current user has the substantive control permission over the breaker control element being clicked in step S704, the alarm system further unlocks the breaker control option of the breaker control element (step S705); if determining that the current user does not have the substantive control permission over the breaker control element being clicked in step S704, the alarm system does not open the breaker control option of the breaker control element.

Next, for the breaker control element being clicked, the alarm system starts the real-time data refresh thread and repeats steps S711-S714 shown in FIG. 7B. In this way, the alarm system displays the real-time value of the breaker control element being clicked, the breaker control option (if unlocked), and the alarm event on the second display area 112 of the graphical control page 11 at the same time for the user to review and control.

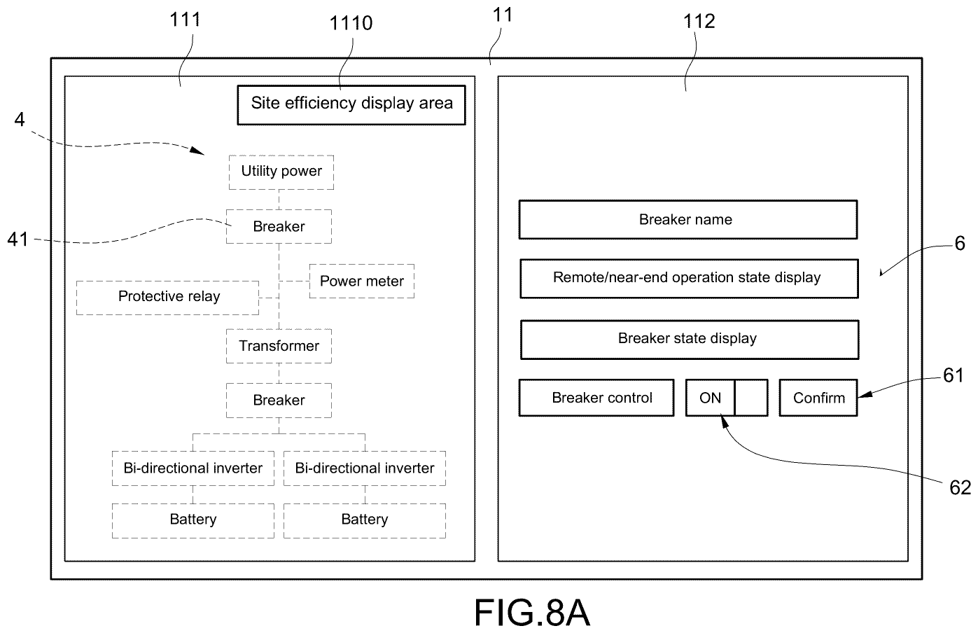

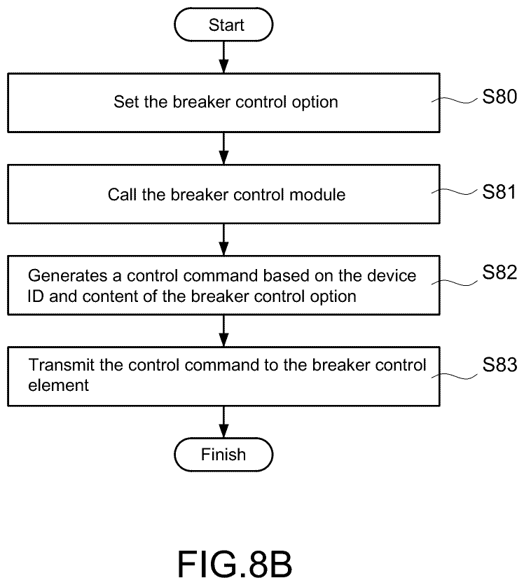

Reference is made to FIG. 8A and FIG. 8B, and FIG. 8A and FIG. 8B respectively are a third embodiment of a schematic diagram of the graphical control page and an embodiment of a flowchart of the device control of the disclosure. As shown in FIG. 8A, when the breaker control element displayed on the graphical control page 11 is clicked, the alarm system displays switch information 6 of this breaker control element, such as a breaker name, a remote/local operation status display, and a breaker status display, in real-time on the second display area 112. If the permission management module 18 determines that the current user has the substantive control permission over the breaker control element in the above step S704, the graphical control page 11 further provides a breaker control area 61 on the second display area 112, and the alarm system unlocks the breaker control option 62 of the breaker control element and displays the breaker control option 62 on the breaker control area 61.

In the embodiment of FIG. 8A, the user operates the breaker control option 62 by a human-machine interface (e.g., operating a pull-down menu to toggle ON/OFF) and changes a breaker state of this breaker control element after pressing a confirmation button.

In the embodiment of FIG. 8A, the second display area 112 of the graphical control page 11 does not display the alarm field 52, but FIG. 8A is just one of the embodiments of the switching control element, and a display panel of the breaker control element still can display one or more alarm fields 52 without being limited to those shown in FIG. 8A.

As shown in FIG. 8B, if the current user has the substantial control permission and the breaker control option 62 is displayed on the graphical control page 11, the user sets the breaker control option 62 on the graphical control page 11 (step S80). After the user completes the setting and presses the confirmation button, the alarm system calls the breaker control module 19 (Step S81), and the breaker control module 19 generates a corresponding control command based on the device ID of the breaker control element being clicked and the content of the breaker control option 62 (Step S82). After step S82, the alarm system transmits the control command to the breaker control element actually installed in the site by underlying communication (step S83), so that changes the breaker state of the breaker control element. By utilizing the alarm system of the disclosure, the user easily and directly operates the specified breaker control element (i.e., the breaker control element being clicked) by the single graphical control page 11, which is quite convenient.

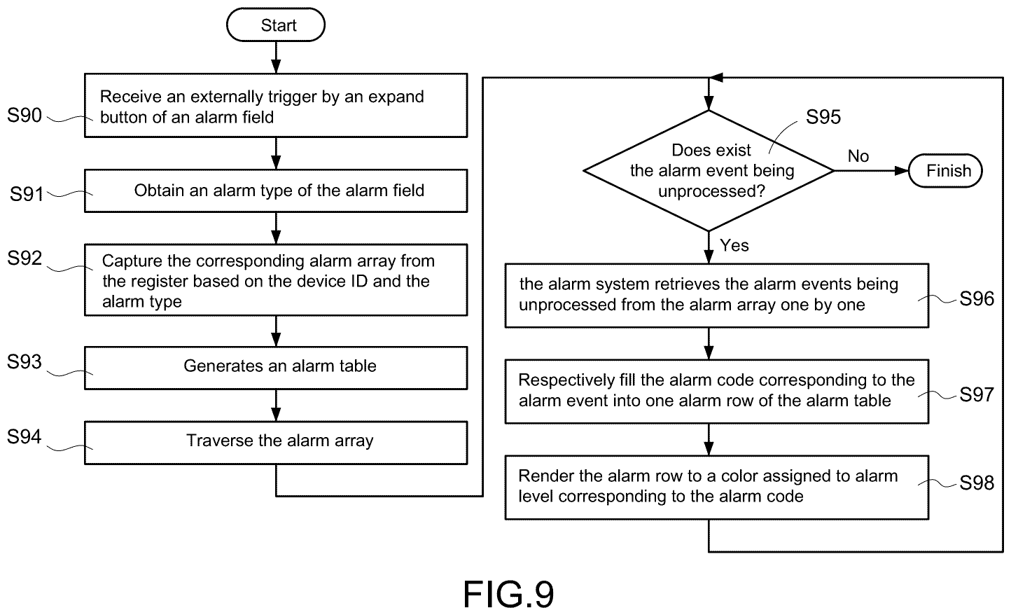

Reference is made to FIG. 9, and FIG. 9 is an embodiment of a flowchart of expanding the alarm field of the disclosure. As shown in FIG. 3B, when any device icon 41 of the electronic device 3 displayed on the first display area 111 of the graphical control page 11 is clicked, the second display area 112 displays device real-time data of the electronic device 3 being clicked and one or more alarm fields 52, where each alarm field 52 is defaulted to a collapsed state and has an expand button 521. At this time, these alarm fields 52 are externally triggered by the expand button 521 (step S90).

When the expand button 521 of any alarm field 52 is triggered, the alarm system obtains the alarm type of the alarm field 52 being triggered (step S91) and queries the register 10 based on the device ID of the electronic device 3 being clicked and the alarm type of the alarm field 52 being triggered to capture the corresponding alarm array from the register 10 (step S92). Next, the alarm system generates the corresponding alarm table based on the content of the alarm array and displays the corresponding alarm table in the expanded alarm field 52. Specifically, the alarm system directly generates and displays the alarm table having multiple alarm rows, and a quantity of the multiple alarm rows is the same as a quantity of the alarm events (or the alarm codes) recorded in the alarm array (Step S93).

After step S93, the alarm system traverses the obtained alarm array (step S94). The alarm system first determines whether any of the alarm events in the alarm array is unprocessed (Step S95), i.e., whether any of the alarm events has not yet been filled into the alarm table. If the determination is positive at step S95, the alarm system retrieves the alarm events being unprocessed from the alarm array one by one (step S96), and respectively fills the alarm codes corresponding to the alarm events into one alarm row of the alarm table 522 (step S97). Further, the alarm system respectively identifies the alarm level of each alarm event based on the alarm code of each alarm event, and respectively renders each alarm row to the color assigned to the alarm level corresponding to the alarm code (Step S98).

For example, if three alarm events are recorded in the alarm array, the alarm system generates the alarm table 522 with three alarm rows and fills each of the three alarm rows with each of the alarm codes for the three alarm events. For example, the alarm code in a first alarm row is a first alarm code, and the first alarm code corresponds to the lowest alarm level; the alarm code in a second alarm row is a second alarm code, and the second alarm code corresponds to the second highest alarm level; and the alarm code in a third alarm row is a third alarm code, and the third alarm code corresponds to the highest alarm level. In this embodiment, the alarm system renders the first alarm row to the color (e.g., gray) corresponding to the lowest alarm level, renders the second alarm row to the color (e.g., yellow) corresponding to the second highest alarm level, and renders the third alarm row to the color (e.g., red) corresponding to the highest alarm level in step S98. In this way, when the user expands the alarm field 52, the user immediately determines the alarm state of the electronic device 3 by the colors of the multiple alarm rows without additionally querying the meaning and severity of each alarm code.

It should be noted that in the disclosure, the alarm system generates the multiple alarm fields 52 based on the alarm types and displays the multiple alarm fields 52 on the graphical control page 11. When the user wants to view the alarm events of a certain type, the user directly triggers the expand button 521 on the alarm field 52 of this type, so that achieves a purpose of fast searching based on the alarm type. By categorically displaying the alarm events, the alarm system of the disclosure assists the user to quickly find the alarm information that the user is looking for when many alarm events of the electronic device 3 exist.

In one embodiment, when the alarm field 52 is expanded, the expand button 521 is converted to a close button 523, and when the close button 523 is triggered, the alarm field 52 is collapsed and the close button 523 is converted to the expand button 521 again. When the expand button 521 is triggered again, the alarm system executes the operations described in FIG. 9 again and regenerates and displays the multiple alarm rows based on the latest data in the register 10. In this way, the user continuously gets the latest alarm information on the second display area 112 of the graphical control page 11.

The alarm field 52 described above displays the alarm code of the electronic device 3 and the color corresponding to the alarm level only after expanded. However, the user needs to click on the device icon 41 of the particular electronic device 3 on the first display area 111 and obtains the above information before clicking on the expand button 521 of the alarm field 52 of the particular alarm type on the second display area 112. In order to more quickly and instantaneously enable the user to obtain the alarm information of each electronic device 3 in the site, in one embodiment, the alarm system performs a color rendering process related to the alarm level for the device icon 41 displayed on the first display area 111 at the same time.

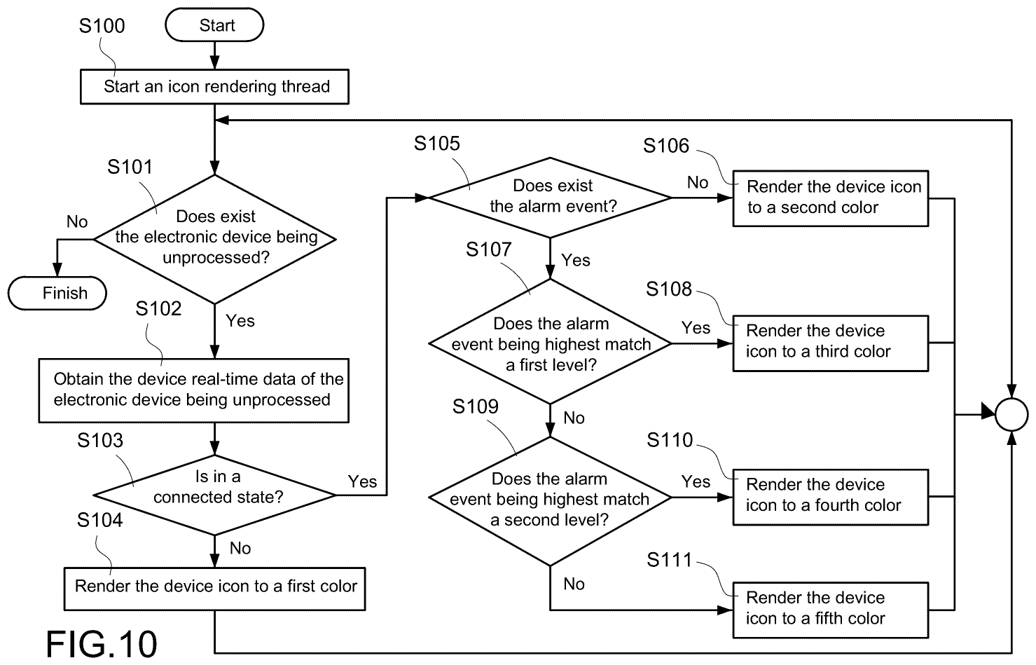

Reference is made to FIG. 10, and FIG. 10 is an embodiment of a flowchart of rendering of the disclosure. As shown in FIG. 10, the alarm system directly starts an icon rendering thread after being activated (step S100). During the operation of the alarm system, the icon rendering thread continuously traverses all electronic devices 3 displayed on the first display area 111 of the graphical control page 11 and performs a color rendering procedure for the device icon 41 of each electronic device 3. In this way, the user immediately knows the current alarm state of each electronic device 3 by simply viewing the dynamic single-line diagram 4 displayed on the first display area 111.

Specifically, the icon rendering thread determines whether the electronic device 3 being unprocessed exists (step S101) at each turn, if the electronic device 3 being unprocessed exists, the icon rendering thread obtains the device real-time data of any electronic devices 3 being unprocessed (step S102) and determines whether the electronic device 3 is in a connected state (step S103). If the electronic device 3 (in the case of a first electronic device) is not in the connected state, the alarm system calls the icon rendering module 14 to render the device icon 41 of the first electronic device on the first display area 111 to a first color (step S104). In this way, when the user views that the device icon 41 of the first electronic device on the first display area 111 is the first color (e.g., black), the user immediately determines that the first electronic device is offline.

If the electronic device 3 is determined to be in the connected state in step S103, the icon rendering thread further determines whether the electronic device 3 has the alarm event (step S105). If the electronic device 3 (in the case of a second electronic device) does not have the alarm event, the alarm system calls the icon rendering module 14 to render the device icon 41 of the second electronic device on the first display area 111 to a second color (Step S106). In this way, when the user views that the device icon 41 of the second electronic device on the first display area 111 is the second color (e.g., green), the user immediately determines that the second electronic device does not have any alarm event and is a stable electronic device.

If the electronic device 3 is determined to have the alarm event in step S105, the icon rendering thread further determines whether the highest alarm level among the one or more alarm events of the electronic device 3 is the first level (step S107). If the highest alarm level of the one or more alarm events of the electronic device 3 (in the case of a third electronic device) is the first level (i.e., the highest alarm level), the alarm system calls the icon rendering module 14 to render the device icon 41 of the third electronic device on the first display area 111 to a third color (step S108). In this way, when the user views that the device icon 41 of the third electronic device on the first display area 111 is the third color (e.g., red), the user immediately determines that the alarm event of the third electronic device is the severity hardly and the alarm event must be troubleshooted immediately.

If determining that the electronic device 3 has one or more alarm events but the highest alarm level of the one or more alarm events is not the first level in step S107, the icon rendering thread further determines whether the highest alarm level of the one or more alarm events is the second level (step S109). If the highest alarm level of the one or more alarm events of the electronic device 3 (in the case of a fourth electronic device) is the second level (i.e., the second highest level), the alarm system calls the icon rendering module 14 to render the device icon 41 of the fourth electronic device on the first display area 111 to a fourth color (step S110). In this way, when the user views that the device icon 41 of the fourth electronic device on the first display area 111 is the fourth color (e.g., yellow), the user immediately determines that the alarm event of the fourth electronic device is the severity second only to the highest level.

The embodiment of FIG. 10 distinguishes the severity of the alarm event in terms of three stages of alarm levels (i.e., the highest level, the second highest level, and the lowest level), but is not limited thereto. If determining that the highest alarm level of the one or more alarm events of the electronic device 3 is not the second highest level in step S109, the icon rendering thread directly determines that the alarm event of this electronic device 3 (a fifth electronic device as an example) is the lowest alarm level. At this time, the alarm system calls the icon rendering module 14 to render the device icon 41 of the fifth electronic device on the first display area 111 to a fifth color (step S111). In this way, when the user views that the device icon 41 of the fifth electronic device on the first display area 111 is the fifth color (e.g., grey), the user immediately determines that the fifth electronic device has the alarm event but not being the severity, and not need to deal with the alarm event immediately.

In the disclosure, each electronic device 3 possibly has the multiple alarm events at the same time. In the above embodiment, the color of the device icon 41 of each electronic device 3 corresponds to the alarm event belonging to the highest alarm level of this electronic device 3. By independently rendering each device icon 41 on the dynamic single-line diagram 4 in color, the user quickly and directly knows the current alarm state of all electronic devices 3 in the site from the single graphical control page 11 without having to go to the site. In this way, the user quickly handles the state of the devices in the site.

While this disclosure has been described by means of specific embodiments, numerous modifications and variations may be made thereto by those skilled in the art without departing from the scope and spirit of this disclosure set forth in the claims.

What is claimed is:

1. An alarm system for electronic devices connected with a plurality of electronic devices in an environment and comprising:
a graphical control page, configured for displaying a device icon of the plurality of electronic devices respectively;
a device alarm identification module, configured for respectively decoding an alarm point of each of the electronic devices, and creating an alarm array based on the alarm points and a plurality of alarm codes of the plurality of electronic devices, wherein each of the alarm codes respectively corresponds to different alarm level;
a register, configured for storing respective device real-time data and the alarm array of the plurality of electronic devices;
a click detection module, configured for, when detecting that the device icon of any of the electronic devices is clicked, reading the device real-time data of the electronic device being clicked from the register, and displaying the device real-time data of the electronic device being clicked on the graphical control page;
a real-time data refresh module, configured for repeatedly reading the register and refreshing displayed content of the graphical control page based on a preset cycle; and
an icon rendering module, configured for rendering a display color of the device icon of the plurality of electronic devices based on data in the register, wherein the display color corresponds to a highest alarm level currently experienced by each of the electronic devices.

2. The alarm system for electronic devices of claim 1, further comprising a device data receiving module, configured for receiving the device real-time data from one of the plurality of electronic devices and, after identifying a device type of the electronic device based on a device ID of the electronic device, decoding the device real-time data being received based on the device type,
wherein the device alarm identification module is configured for performing an alarm determination based on the alarm point native to the electronic device according to the device real-time data being received, and when the electronic device is determined to have an alarm event, storing the alarm code corresponding to the alarm event to the alarm array.

3. The alarm system for electronic devices of claim 1, wherein the graphical control page has a first display area and a second display area, the first display area is configured for displaying the device icon of the plurality of electronic devices, and the second display area is configured for displaying device real-time data of the plurality of electronic devices,
wherein the device icon of the plurality of electronic devices constitutes a dynamic single-line diagram, and the dynamic single-line diagram corresponds to a power network formed by the plurality of electronic devices in the environment.

4. The alarm system for electronic devices of claim 3, wherein when the device icon of any of the electronic devices is clicked, the second display area is configured for displaying the device real-time information of the electronic device being clicked and a plurality of alarm fields,
wherein the plurality of alarm fields respectively corresponds to different alarm types, and the plurality of alarm fields are defaulted to a collapsed state and respectively have an expand button.

5. The alarm system for electronic devices of claim 4, wherein when the expand button of any of the alarm fields is triggered, the alarm system reads the register to correspondingly obtain the alarm array based on the device ID of the electronic device being clicked and the alarm type of the alarm field being triggered, and generates and displays an alarm table based on content of the alarm array, wherein the alarm table has a plurality of alarm rows, wherein each of the alarm rows respectively records a certain alarm code in the alarm array, and each of the alarm rows is rendered to a color assigned to the alarm level corresponding to the certain alarm code.

6. The alarm system for electronic devices of claim 3, wherein when the click detection module detects that the device icon of any of the electronic devices is clicked, the alarm system identifies a device type of the electronic device being clicked as a breaker control element, a system efficiency element, or a general element based on a device ID of the electronic device being clicked, and displays different content on the second display area based on the device type.

7. The alarm system for electronic devices of claim 6, wherein when the electronic device being clicked is the general element, the alarm system executes following operations:
starting a real-time data refresh thread;
correspondingly reading the device real-time data from the register based on the device ID of the electronic device being clicked;
calling the real-time data refresh module to refresh real-time values displayed on the second display area based on the device real-time data of the electronic device being clicked; and
before leaving the real-time data refresh thread, delaying the real-time data refresh thread for a period of system time, and performing the real-time data refresh thread again.

8. The alarm system for electronic devices of claim 7, wherein when the electronic device being clicked is the breaker control element, the alarm system executes following operations:
calling a permission management module to obtain a user control permission for a current user;
determining whether the current user possesses a substantive control permission over the breaker control element based on the user control permission;
when determining that possesses a substantive control permission over the breaker control element, unlocking a breaker control option of the breaker control element;
starting the real-time data refresh thread;
correspondingly reading the device real-time data of the electronic device being clicked from the register based on the device ID of the electronic device being clicked;
calling the real-time data refresh module to refresh the real-time values and the breaker control option displayed on the second display area based on the device real-time data of the electronic device being clicked; and
before leaving the real-time data refresh thread, delaying the real-time data refresh thread for the period of system time, and performing the real-time data refresh thread again.

9. The alarm system for electronic devices of claim 6, wherein when the electronic device being clicked is the system efficiency element, the alarm system executes following operations:
calling a system efficiency calculation module to calculate a system efficiency of the electronic device being clicked;
displaying the system efficiency on the second display area; and
drawing a system efficiency curve graph based on the system efficiency and displaying the system efficiency curve graph on that second display area.

10. The alarm system for electronic devices of claim 3, wherein the alarm system starts an icon rendering thread and the icon rendering thread performs:
traversing the plurality of electronic devices displayed on the first display area, and when a first electronic device in the plurality of electronic devices is not connected, calling the icon rendering module to render the device icon of the first electronic device to a first color;
when a second electronic device in the plurality of electronic devices is connected and does not have any alarm event, calling the icon rendering module to render the device icon of the second electronic device in the plurality of electronic devices to a second color;
when a third electronic device in the plurality of electronic devices has alarm events and a highest alarm level of the alarm events is a first level, calling the icon rendering module to render the device icon of the third electronic device to a third color;
when a fourth electronic device in the plurality of electronic devices has alarm events and the highest alarm level of the alarm events is a second level, calling the icon rendering module to render the device icon of the fourth electronic device to a fourth color; and
when a fifth electronic device in the plurality of electronic devices has alarm events and the highest alarm level of the alarm events is a third level, calling the icon rendering module to render the device icon of the fifth electronic device to a fifth color.

11. An alarm method for electronic devices, applied to an alarm system connected with a plurality of electronic devices in an environment, and comprising:
step a) by a graphical control page in the alarm system, displaying a device icon of the plurality of electronic devices respectively;
step b) by a device alarm identification module in the alarm system, respectively decoding an alarm point of each of the electronic devices, and creating an alarm array based on the alarm point and a plurality of alarm codes of the plurality of electronic devices, wherein each of the alarm codes respectively corresponds to different alarm level;
step c) storing respective device real-time data and the alarm array of the plurality of electronic devices to a register in the alarm system;
step d) when detecting that the device icon of any of the electronic devices is clicked, by a click detection module in the alarm system, reading the device real-time data of the electronic device being clicked from the register, and displaying the device real-time data of the electronic device being clicked on the graphical control page;
step e) by a real-time data refresh module in the alarm system, repeatedly reading the register and refreshing displayed content of the graphical control page based on a preset cycle; and
step f) by an icon rendering module in the alarm system, rendering a display color of the device icon of the plurality of electronic devices based on data in the register, wherein the display color corresponds to a highest alarm level currently experienced by each of the electronic devices.

12. The alarm method for electronic devices of claim 11, wherein the alarm system further comprises a device data receiving module, and wherein the step b) comprises:
step b1) by the device data receiving module, receiving the device real-time data from one of the plurality of electronic devices;
step b2) identifying a device type of the electronic device based on a device ID of the electronic device, and decoding the device real-time data being received based on the device type;
Step b3) by the device alarm identification module, performing an alarm determination based on the alarm point native to the electronic device according to the device real-time data being received; and
step b4) when the electronic device is determined to have an alarm event, by the device alarm identification module, storing the alarm code corresponding to the alarm event to the alarm array.

13. The alarm method for electronic devices of claim 11, wherein the graphical control page has a first display area and a second display area, the first display area displays the device icon of the plurality of electronic devices, and the second display area displays device real-time data of the plurality of electronic devices,
wherein the device icon of the plurality of electronic devices constitutes a dynamic single-line diagram, and the dynamic single-line diagram corresponds to a power network formed by the plurality of electronic devices in the environment.

14. The alarm method for electronic devices of claim 13, wherein the step d) comprises:
when clicking on the device icon of any of the electronic devices, by the second display area, displaying the device real-time data of the electronic device being clicked and a plurality of alarm fields,
wherein each of the plurality of alarm fields corresponds to a different alarm type, is set to a collapsed state by default, and has an expand button.

15. The alarm method for electronic devices of claim 14, wherein the step d) comprises:
step d11) by the expand button of any of the alarm fields, accepting a trigger;
step d12) obtaining an alarm type of the alarm field being triggered;
step d13) by the alarm system, reading the register to correspondingly obtain the alarm array based on the device ID of the electronic device being clicked and the alarm type of the alarm field being triggered;
step d14) generating and displaying an alarm table based on content of the alarm array, wherein the alarm table has a plurality of alarm rows;
step d15) sequentially capturing a plurality of alarm events in the alarm array and filling the alarm codes corresponding to the plurality of alarm events into the plurality of alarm rows in the alarm table; and
step d16) rendering each of the alarm rows to a color assigned to the alarm level corresponding to the alarm code in each of the alarm rows.

16. The alarm method for electronic devices of claim 14, wherein the step d) comprises:
step d21) when the click detection module detects that the device icon of any of the electronic devices is clicked, identifying a device type of the electronic device being clicked as a breaker control element, a system efficiency element, or a general element;
step d22) when the electronic device being clicked is the general element, starting a real-time data refresh thread;
step d23) correspondingly reading the device real-time data from the register based on the device ID of the electronic device being clicked;
step d24) calling the real-time data refresh module to refresh a real-time value displayed on the second display area based on the device real-time data of the electronic device being clicked; and
step d25) before leaving the real-time data refresh thread, delaying the real-time data refresh thread for a period of system time, and performing the real-time data refresh thread again.

17. The alarm method for electronic devices of claim 16, wherein the step d) further comprises:
step d31) when identifying that the electronic device being clicked is the breaker control element, calling a permission management module in the alarm system to obtain a user control permission of a current user for the alarm system;
step d32) determining whether the current user possesses a substantive control permission over the breaker control element based on the user control permission;
step d33) when determining that possesses a substantive control permission over the breaker control element, unlocking a breaker control option of the breaker control element; and
step d34) starting the real-time data refresh thread, and repeatedly executing the steps d23) to d25), wherein the real-time values and the breaker control option of the breaker control element are displayed on the second display area at the same time.

18. The alarm method for electronic devices of claim 17, wherein the step d) further comprises:
step d41) when determining that the electronic device being clicked is the system efficiency element, calling a system efficiency calculation module of the alarm system to calculate a system efficiency of the electronic device being clicked;
step d42) displaying the system efficiency on the second display area; and
step d42) drawing a system efficiency curve graph based on the system efficiency and displaying the system efficiency curve graph on the second display area.

19. The alarm method for electronic devices of claim 13, wherein the step f) comprises:
step f1) by the alarm system, starting an icon rendering thread, and by the icon rendering thread, traversing the plurality of electronic devices displayed on the first display area;
step f2) when a first electronic device in the plurality of electronic devices is not connected, calling the icon rendering module to render the device icon of the first electronic device to a first color;
step f3) when a second electronic device in the plurality of electronic devices is connected and does not have any alarm event, calling the icon rendering module to render the device icon of the second electronic device to a second color;
step f4) when a third electronic device in the plurality of electronic devices has alarm events and the highest alarm level of the alarm events is a first level, calling the icon rendering module to render the device icon of the third electronic device to a third color;
step f5) when a fourth electronic device in the plurality of electronic devices has alarm events and the highest alarm level of the alarm events is a second level, calling the icon rendering module to render the device icon of the fourth electronic device to a fourth color; and
step f6) when a fifth electronic device in the plurality of electronic devices has alarm events and the highest alarm level of the alarm events is a third level, calling the icon rendering module to render the device icon of the fifth electronic device to a fifth color.

20. A non-transitory storage medium, storing an application program having a plurality of computer-readable codes, and executing the steps of the alarm method for electronic devices of claim 11 when executing the plurality of computer-readable codes.
